(19) United States
(12) Patent Application Publication
(10) Pub. No.: US 2012/0145700 A1
(43) Pub. Date: Jun. 14, 2012

(54) ELECTRICAL HEATING WIRE CONTAINING CARBON FIBER

(76) Inventors: I-Shou TSAI, Longjing Township (TW); Lin-Ho LIU, Zhuqi Township (TW)

(21) Appl. No.: 12/967,958

(22) Filed: Dec. 14, 2010

(51) Int. Cl. H05B 3/56

(52) U.S. Cl. 219/549

(57) ABSTRACT

An electrical heating wire containing carbon fiber includes a heating unit and an insulation sleeve cladding on the heating unit. The heating unit is a carbon fiber bundle constituted by plural carbon fiber yarns or a structure formed by wrapping, weaving or twining the carbon fiber bundle with at least one element among a glass fiber bundle, a rock fiber bundle, a ceramic fiber bundle and a DuPont Kevlar® are fiber bundle (aromatic polyamide fiber bundle). The carbon fiber yarn can be a structure with metal particles on the surface, a dual-layered structure with a metal layer or a graphite layer on the surface, or a porous structure. Accordingly, by the present invention, the thermal conductivity can be increased, the resistance can be reduced, the thermal diffusion coefficient can be increased, the weight can be reduced and the hygroscopicity can be improved, thus providing a better efficiency of electrical heating.

### BACKGROUND OF THE INVENTION

a) Field of the Invention

The present invention relates to an electrical heating wire containing carbon fiber and more particularly to an electrical heating wire, wherein carbon fiber yarns in a carbon fiber bundle are modified to increase the thermal conductivity, reduce the resistance, increase the thermal diffusion coefficient, decrease the weight and improve the hygroscopicity, thereby providing a better efficiency of electrical heating.

b) Description of the Prior Art

Nowadays, there are a lot of technologies that can be applied to access a heat source. For example, a technology which utilizes primarily a compressor for heat exchange is provided with extremely high costs of equipment and the heat source; therefore, its economic benefit needs to be evaluated carefully.

On the other hand, there is another kind of electrical heating technology that can be used to acquire the heat source and this includes electrical heating filaments which are very highly dependent upon by all kinds of industries and merchandises thereof and an electrical heating wires containing carbon fiber, which is widely used now. A general heating principle of the electrical heating technology uses primarily a conductance loop to generate heat energy from its resistance by conducting with electric current. However, as most electrical heating elements are pre-designed with the conductance loop to match a pre-determined installation space according to types and demands of merchandises, this single-typed electrical heating element will not be able to be totally applied to all kinds of merchandises, which will result in issues of insufficient efficiency of production and not being able to effectively improve the economic benefit. When more heating is required, plural heating elements will normally be connected serially due to a limitation of manufacturing machines, in order to match the required heating efficiency. In addition, this method is also provided with issues of a large load of voltage and a load limitation of the electric current of the conductance loop.

### SUMMARY OF THE INVENTION

The primary object of the present invention is to provide an electrical heating wire containing carbon fiber, which includes a heating unit and an insulation sleeve cladding on the heating unit, wherein the said heating unit is a carbon fiber bundle constituted by plural carbon fiber yarns or a structure which is formed by wrapping, weaving or twining the carbon fiber bundle with at least one element among a glass fiber bundle, a rock fiber bundle, a ceramic fiber bundle and a DuPont Kevlar® fiber bundle (aromatic polyamide fiber bundle).

In the present invention, to direct against the low hygroscopicity and high resistance of the existing electrical heating wire with carbon fiber, an outer surface of the carbon fiber yarn in the above-mentioned electrical heating wire containing carbon fiber is primarily coated with a metal particle structure of high surface area, in which the metal particles are modified, thereby increasing the thermal conductivity and reducing the resistance of the carbon fiber yarn.

In the present invention, to direct against the low hygroscopicity and high resistance of the existing electrical heating wire with carbon fiber, the carbon fiber yarn in the abovementioned electrical heating wire containing carbon fiber is primarily treated with modification of the metal film coating to form a dual-layered structure having the metal layer, thereby increasing the thermal conductivity and reducing the resistance of the carbon fiber yarn.

In the present invention, to direct against the low hygroscopicity and high resistance of the existing electrical heating wire with carbon fiber, the carbon fiber yarn of the abovementioned electrical heating wire containing carbon fiber is primarily treated with modification in high frequency (high cycle) to form a structure, a surface of which is graphitized, thereby allowing the carbon fiber yarn to have a lower resistance.

In the present invention, to direct against the low hygroscopicity and high resistance of the existing electrical heating wire with carbon fiber, the carbon fiber yarn of the abovementioned electrical heating wire containing carbon fiber is primarily treated with modification of acid wash or alkali wash to form a porous structure, thereby allowing the carbon fiber yarn to have a better hygroscopicity, a higher thermal diffusion coefficient and lower weight.

In the present invention, the said insulation sleeve can be a heat-resistant tube or a braided tube. The said heat-resistant tube can be a fluoroelastomer tube, a silicon tube, a PU (polyurethane) tube, a PVC (polyvinylchloride) tube, a PE (polyethylene) tube, a PP (polypropylene) tube, a PET (polyester) tube, a Nylon tube (or polyamide tube) or a PI (polyimide) tube; whereas, the said braided tube can be assembled from at least one of the glass fiber bundle, the rock fiber bundle, the ceramic fiber bundle or the DuPont Kevlar® fiber bundle.

In addition to insulating from electricity, the said insulation sleeve is also capable of protecting the carbon fiber bundle from friction and breakage, wherein the heat-resistant tube is provided with a better water-proof property but a larger heat loss and thus is preferably used in water heating. On the other hand, the braided tube is provided with gaps that heat can be dissipated easily. Therefore, the braided tube is capable of adjusting heat and thus is provided with a smaller heat loss. However, the water-proof property is inferior. Accordingly, the braided tube is preferably applied to a target other than water, such as clothes or fabric.

In the present invention, the said braided tube is assembled from at least one element among the glass fiber bundle, the rock fiber bundle, the ceramic fiber bundle and the DuPont Kevlar® fiber bundle.

In the present invention, the said metal particles are in a shape of a ball, a rod, a square, a rectangle, a triangle or other geometric object.

The implementation of the electrical heating wire containing carbon fiber, according to the present invention, is provided with the benefits of enabling the carbon fiber yarn to have a lower resistance, a better hygroscopicity, a higher thermal diffusion coefficient and lower weight.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an electrical heating wire containing carbon fiber, according to the present invention.

FIG. 2 shows a schematic view of a transversal cross section of FIG. 1, according to the present invention.

FIG. 3 shows a structural schematic view of a carbon fiber bundle, according to the present invention.

FIG. 4 shows a structural schematic view of a twined carbon fiber bundle, according to the present invention.

FIG. 5 shows a structural schematic view of a carbon fiber yarn, a surface of which is provided with metal particles of high surface area, according to the present invention.

FIG. 6 shows a structural schematic view of the metal particles of all kinds of shapes in FIG. 5, according to the present invention.

FIG. 7 shows a structural schematic view of a dual-layered carbon fiber yarn, a surface of which is provided with a metal layer, according to the present invention.

FIG. 8 shows a structural schematic view of a dual-layered carbon fiber yarn, a surface of which is provided with a graphite layer, according to the present invention.

FIG. 9 shows a structural schematic view of a porous carbon fiber yarn, according to the present invention.

### DETAILED DESCRIPTION OF THE PREFERRED EMBODIMENTS

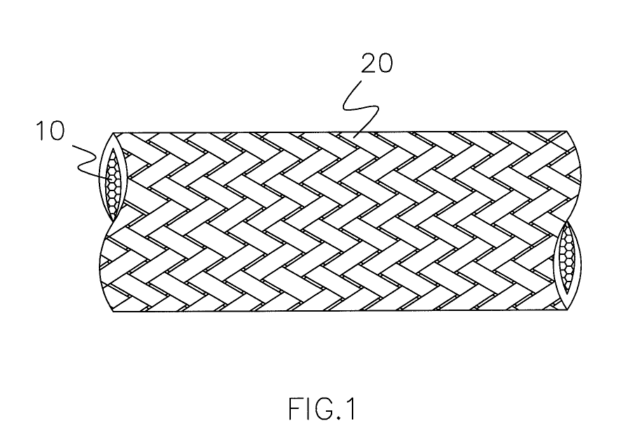

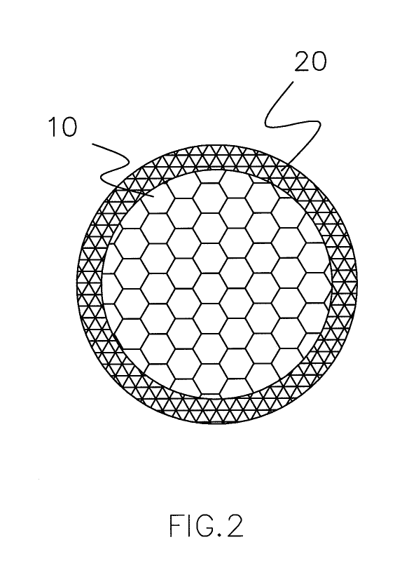

Referring to FIG. 1 and FIG. 2, FIG. 1 shows a schematic view of an electrical heating wire containing carbon fiber, according to the present invention; whereas, FIG. 2 shows a schematic view of a transversal cross section of FIG. 1. The electrical heating wire containing carbon fiber, as shown in FIG. 1 and FIG. 2, comprises a heating unit 10 and an insulation sleeve 20 cladding on the heating unit 10. The said insulation sleeve 20 can be a heat-resistant tube or a braided tube. The said heat-resistant tube can be a fluoroelastomer tube, a silicon tube, a PU tube, a PVC tube, a PE tube, a PP tube, a PET tube, a Nylon tube or a PI tube; whereas, the said braided tube can be assembled from at least one element among a glass fiber bundle, a rock fiber bundle, a ceramic fiber bundle and a DuPont Kevlar® bundle, as shown in FIG. 1. In addition to insulating from electricity, the said insulation sleeve is also capable of protecting the carbon fiber bundle from friction and breakage; wherein, the heat-resistant tube is provided with a better water-proof property but a larger heat loss, and thus is preferably used in water heating. On the other hand, the braided tube is provided with gaps that heat can be dissipated easily. Therefore, the braided tube is capable of adjusting heat and is provided with a smaller heat loss. However, the braided tube is provided with an inferior water-proof property. Accordingly, the braided tube is preferably applied to a target other than water, such as clothes or fabric.

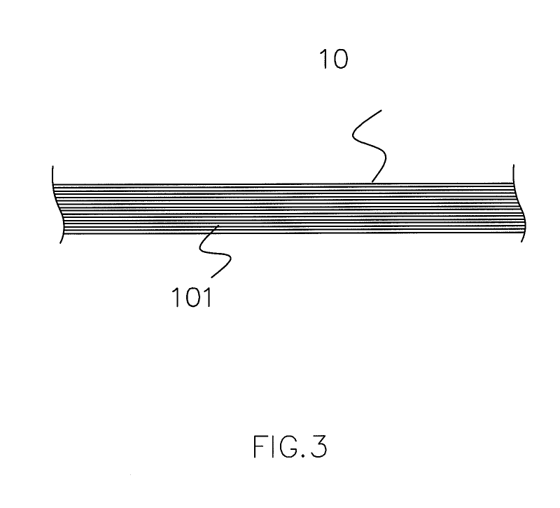

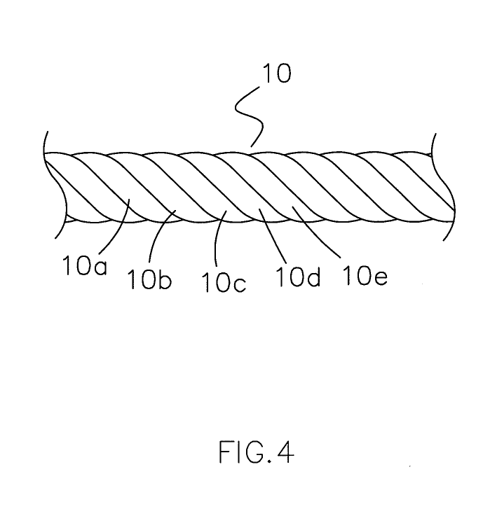

Furthermore, as shown in FIG. 3, the said heating unit 10 can be a carbon fiber bundle which is constituted by plural carbon fiber yarns 101, or, as shown in FIG. 4, can be a structure which is formed by wrapping, weaving or twining a carbon fiber bundle 10a with at least one element among a glass fiber bundle 10b, a rock fiber bundle 10c, a ceramic fiber bundle 10d and an aromatic polyamide fiber bundle 10e (the DuPont Kevlar® fiber bundle).

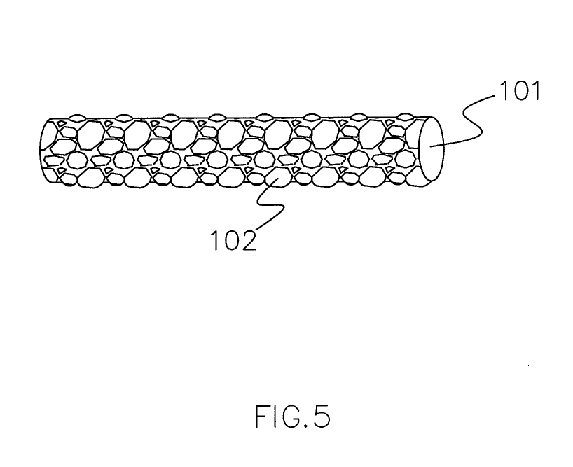

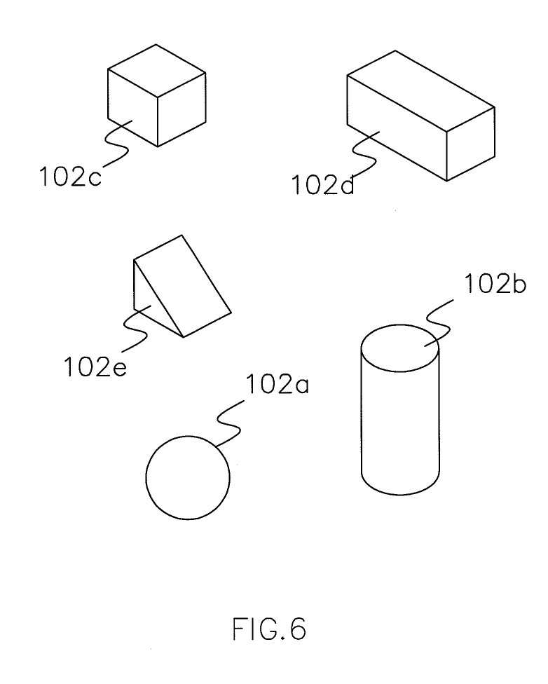

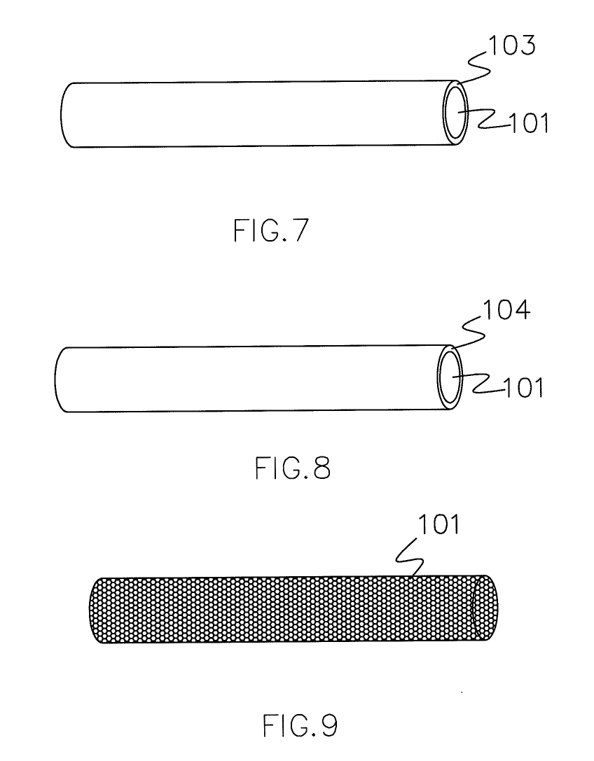

On the other hand, to increase the thermal conductivity and reduce the resistance, as shown in FIG. 5, a surface of the carbon fiber yarn 101 in the carbon fiber bundle can be provided with a structure of metal particles 102 which can be in any shape, such as a ball-shaped metal particle 102a, a rod-shaped metal particle 102b, a square-shaped metal particle 102c, a rectangular metal particle 102d, a triangular metal particle 102e or a metal particle of other shape, as shown in FIG. 6. As shown in FIG. 7, the carbon fiber yarn 101 can be a dual-layered structure with a metal layer 103 on the surface; whereas, as shown in FIG. 8, the carbon fiber yarn 101 can be a dual-layered structure with a graphite layer 104 on the surface. In addition, the carbon fiber yarn 101 can be a porous structure, as shown in FIG. 9.

Accordingly, the implementation of the present invention is provided with following advantages:
1. The surface of the carbon fiber yarn is provided with the metal particles of high surface area to reduce the resistance and increase the thermal conductivity.
2. The carbon fiber yarn is the dual-layered structure with the metal layer on the surface to reduce the resistance and increase the thermal conductivity.
3. The carbon fiber yarn is the dual-layered structure with the graphite layer on the surface to reduce the resistance and increase wear resistance.
4. The carbon fiber yarn is the porous structure to increase the thermal diffusion coefficient, reduce the weight and improve the hygroscopicity.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electrical heating wire containing carbon fiber comprising a heating unit which is a carbon fiber bundle constituted by plural carbon fiber yarns and an insulation sleeve cladding on the heating unit.

2. The electrical heating wire containing carbon fiber, according to claim 1, wherein the carbon fiber bundle is formed by wrapping, weaving or twining the carbon fiber bundle with at least one element among a glass fiber bundle, a rock fiber bundle, a ceramic fiber bundle and an aromatic polyamide fiber bundle.

3. The electrical heating wire containing carbon fiber, according to claim 1, wherein a surface of the carbon fiber yarn is provided with a metal particle structure of high surface area.

4. The electrical heating wire containing carbon fiber, according to claim 1, wherein the carbon fiber yarn is a dual-layered structure, with a metal layer on the surface thereof.

5. The electrical heating wire containing carbon fiber, according to claim 1, wherein the carbon fiber yarn is a dual-layered structure, with a graphite layer on the surface thereof.

6. The electrical heating wire containing carbon fiber, according to claim 1, wherein the carbon fiber yarn is a porous structure.

7. The electrical heating wire containing carbon fiber, according to claim 1, wherein the insulation sleeve includes a heat-resistant tube or a braided tube.

8. The electrical heating wire containing carbon fiber, according to claim 7, wherein the heat-resistant tube includes a fluoroelastomer tube, a silicon tube, a PU (polyurethane) tube, a PVC (polyvinylchloride) tube, a PE (polyethylene) tube, a PP (polypropylene) tube, a PET (polyester) tube, a Nylon tube or a PI (polyimide) tube.

9. The electrical heating wire containing carbon fiber, according to claim 7, wherein the braided tube includes a braided tube which is assembled from at least one element among a glass fiber bundle, a rock fiber bundle, a ceramic fiber bundle and an aromatic polyamide fiber bundle.

10. The electrical heating wire containing carbon fiber, according to claim 3, wherein the metal particles are in a shape of a ball, a rod, a square, a rectangle or a triangle.
